(19) United States
(12) Patent Application Publication
(10) Pub. No.: US 2004/0137813 A1
(43) Pub. Date: Jul. 15, 2004

(54) Air and vapor barrier sheathing system

(75) Inventor: Denis Faucher, Chateau-Richer (CA)

Correspondence Address: OGILVY RENAULT, 1981 MCGILL COLLEGE AVENUE, SUITE 1600, MONTREAL, QC, H3A2Y3, CA

(73) Assignee: MATERIAUX DFC INC., Quebec (CA)

(21) Appl. No.: 10/338,857

(22) Filed: Jan. 9, 2003

(51) Int. Cl. B32B 5/22

(52) U.S. Cl. 442/76; 442/59

(57) ABSTRACT

A laminated panel comprising an air and vapor barrier membrane is provided. Heating of the barrier membrane allows self-adhesion to a surface on which it is applied after transudation of fusion of the sealing material through the support sheets. The air and vapor barrier membrane of the present invention also allows for application without releasing of a liner for the application on a surface to be sealed or protected.

### TECHNICAL FIELD

The present invention relates to a laminated panel serving as air/vapor barrier, and which does not require the removal of a release sheet liner before applying it on a surface, wall or structure to be protected from weather conditions. More particularly, the laminated panel of the present invention integrates a waterproofing membrane allowing self sealing of mechanical fasteners, provides a continuous air/vapor barrier membrane, and permits a self-adhesion of the panel on a surface.

### BACKGROUND OF THE INVENTION

Air leakage can account for an important part of the total heat loss in houses because warm air leaks out while cold air leaks in. Along with the air, moisture (vapor) escapes and can condense inside the walls or attics which could cause serious structural damage when mold, mildew and rot occur. A good seal ensures less air infiltration as well as drier insulation in building interiors.

To avoid air and vapor transfers, new-building manufacturers use state of the art products to create an air/vapor barrier envelope. The most important property of an air-vapor barrier is the ability to resist air flow and air pressure. A continuous air/vapor barrier completely encloses air within a building, keeping moisture from entering insulated cavities where it can condense into water. At the opposite, a vapor retarder inhibits vapor diffusion, but remains partially permeable to air and humidity.

Bitumen-based layers are often applied to masonry or sheathing material to create an air barrier system. These membranes are relatively impermeable to water, and thus constitute vapor barriers.

Bitumen-based membranes normally feature a reinforcement made of non-woven polyester cloth or of a layer of reinforced glass such as fiberglass. One of the membrane surfaces is coated with small slate flakes of various colors, similar to granules, for protection against ultraviolet rays.

The users of these types of membranes currently face serious problems when trying to seal together contiguous membranes because of the relatively complex steps that must be carried out to adhere bituminous membranes to vertical substrates. Of course, if an effective adhesion is not attained, the membrane system will leak and will not achieve its purpose.

Most of membranes known in the art for sealing a structure or a surface require the peeling of one part, such as a non-adherent sheet on one face of a impervious layer before application on the surface.

Air/vapor barrier membranes are generally obtained in sheets of 1.0 1.5, 3, 4 or 5 mm thickness and, if total or partial adhesion to the support is required, they can be applied either by means of a propane-gas torch, which by liquefying the bituminous mass causes it to adhere to the support.

However, while membranes based on bitumen modified with styrene-butanediene-styrene (SBS) as known in the art, yield good results with both methods (with preference for the air blow bitumen method, due to some limitations of the SBS membrane with the torch method, such as risk of fire), it is recognized in the art that polyolefin-based membranes generally yield the best results only with the flame method.

The problems of handling during application of air/vapor barrier membranes because of contact adhesives, the removal of paper, or because of the use of a torch, demonstrate that there is still an important need in the art for new air/vapor barrier membranes.

It can be seen from the art described above that there are still needs for new laminated panel assemblies and air/vapor barrier membranes allowing impervious coverage of structures and walls in the field of construction.

### SUMMARY OF THE INVENTION

One object of the present invention is to provide a laminated panel substantially impervious to atmospheric air and vapor comprising a board, the board having one surface covered with a sealing membrane, the sealing membrane comprising a layer of sealing material having one side coated with a layer of impervious non transudent surfacing material that is in adhesive contact with the layer of sealing material, and a second side coated with a support sheet comprised of a therethrough so as to allow the sealing membrane the board. The bitumen may be a polymer-modified asphalt, and the layer of sealing material has generally a thickness of between 0.1 to 8 mm.

It will be recognized by someone skilled in the art that the support sheet is sufficiently porous to permit passage of said sealing material therethrough.

Also, the adherent support sheet my be further penetrated by an adhesive material previously applied thereto or on a surface on which the integrated sealing membrane is applied.

The sealing material generally comprises a water repellant material that can be selected from the group consisting of a transudent bitumen, a transudent polymer, a transudent resin, and a mixture thereof.

Alternatively, the board is a panel of wood, concrete, gypsum, perlite, kraft, foam, wood fiber, plywood, insulating material, a paper sheet, or a metallic sheet.

It will be understood by those skilled in the art that the impervious non transudent surfacing material can be selected from the group consisting of a polymer, a resin, a plastic, a metal, a polyester, a polypropylene, a polybutyrene, a polyimide, a polycarbonate, a polyamide, a polyethylene, a polystyrene, a polyvinylchloride, a fluoroplastic, a sulfone polymer, and a polyvinylidene chloride.

The support sheet of the laminated panel described herein may be made of fiber comprising Kraft paper, a fabric, or a mixture thereof.

The laminated panel of claim 1, wherein the sealing material comprises between 50 to 100% of bitumen, and up to 50% by weight of at least one copolymer, wherein combination of said bitumen and the copolymer forms 100% of said sealing material. The bitumen copolymer combination may consists of a styrene-butadiene-styrene, block copolymer.

Another object of the present invention is to provide method for protecting a construction against atmospheric air or vapor comprising:

a) providing a laminated panel as defined herein;

b) heating the laminated panel on a side of the sealing membrane having the layer of impervious non transudent, surfacing material for a time and a temperature allowing the heated side to become adhesive; and

c) applying the heated laminated panel of step b) on a construction surface in manner to the allow self-adhesion of the laminated panel to the construction surface.

The method comprises laminating the board with the sealing membrane before or after adhesion to the construction surface.

Another object of the present invention is to provide a paneling material, at least partially covered, with the air/vapor barrier membrane of the present invention.

The sealing material layer may be composed of transuding material selected from the group consisting of a bitumen, a polymer, and a resin, wherein the bitumen can be polymer-modified asphalts.

The sealing material may further comprise up to 50% by weight of a filler.

The sealing material may comprise between 50 to 100% of bitumen, and up to 50% by weight of at least one copolymer. The mixture of the bitumen and a copolymer generally forms 100% of the sealing material. The copolymer can be composed of ethylene, propylene, butene, derivative or mixture thereof.

For the purpose of the present invention the following terms are defined below.

The term “bitumen” as used herein is intended to mean residue from atmospheric distillation of crude oil or of a mixture thereof with a slightly oxidized product. The softening point of the various types varies from 36° C. to 140° C., and the penetration number is generally comprised between 40 to 350 dmm; bitumen which have a penetration number comprised between 60 to 220 dmm and a softening point comprised between 60° C. and 120° C. are preferably used for modification with polymers. It is furthermore possible to use a mixture of various types of bitumen, and the properties of the bitumen can be modified by adding mineral oils, fatty substances, chemical agents which make it impenetrable to roots, and others.

The term “copolymer” as used herein is intended to mean an elastic polymer which may be formed with ethylene, polyester, polypropylene, polybutyrene, polyimide, polycarbonate, polyamide, polyethylene, polystyrene, polyvinylchloride, fluoroplastics, sulfone polymers, polyvinylidene chloride, butene, derivatives or mixtures thereof. The ratios of polymers used in preparing a mixture may vary depending of the physical and chemical properties needed in a sealing material. For example, a sealing material according to the present invention may comprise between 5 to 15% by weight of copolymers. Also, for example, one type of mixture of copolymers, which can be used in the sealing material, may comprises between 25 to 70% propylene, 20 to 70% butene and 0 to 15% ethylene

The terms “sealing” or “sealed” as used herein are intended to mean the capacity or property of a material to significantly prevent the passage of a gas or a liquid through a material or a structure.

The terms “transudent” or “transuding” as used herein is intended to mean the capacity or property of a material to transude, to exude, to excrete, to fuse, to transpire, to diffuse, or to pass through pores or interstices of a layer, as a sheet of paper for example. A matter capable to transude, slowly or rapidly, may be liquid, viscous, or pasty, and may have a physical state, meaning that the transuding matter may be more or less viscous for example, depending on the ambient temperature. The support sheets on both sides of the barrier membrane of the present invention can be either transuding of non-transuding. A non transuding material is relatively solid, and does not transude, exude, excrete, transpire, diffuse, or pass through pores or interstices.

The term “waterproofing material” as used herein is intended to mean a material that can have the function of air barrier, vapor barrier, moisture barrier, or combinations thereof. A waterproofing membrane as used herein is generally comprised of such waterproofing material and has the characteristics conferred by this material. Therefore, a “waterproofing membrane” is intended to be used herein as being a barrier for air, vapor, gas, water or other aqueous liquids.

### BRIEF DESCRIPTION OF THE DRAWINGS

Further features and advantages of the present invention will become apparent from the following detailed description, taken in combination with the appended drawings, in which:

FIG. 1 illustrates a cross-section view of a laminated panel constructed in accordance with one embodiment of the present invention;

FIG. 2 illustrates according to one embodiment of the present invention a cross-section view of a laminated panel adhered to a surface with fixing means;

FIG. 3 illustrates the laminated panel of the instant invention adhered to a gypsum board on one side and to an insulating board on the other side; and

FIG. 4 illustrates a perspective view of panels secured to studs and sealed together.

It will be noted that throughout the appended drawings, like features are identified by like reference numerals.

### DETAILED DESCRIPTION OF THE PREFERRED EMBODIMENT

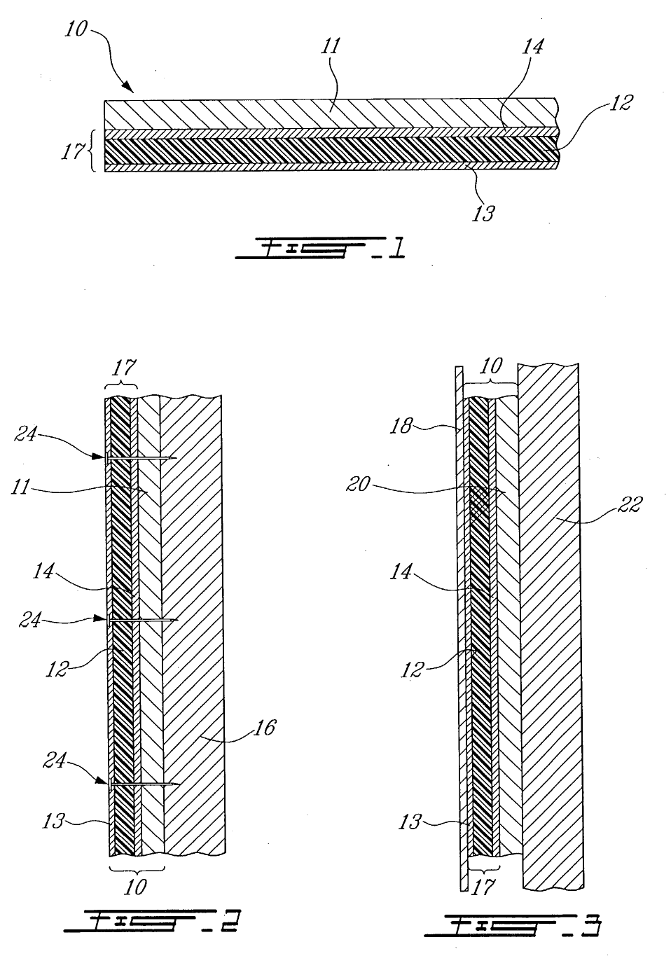

As illustrated in FIG. 1, a laminated panel 10 constructed in accordance with one embodiment of the present invention includes a board 11, and a waterproofing membrane 17 applied against one face of board 11. The waterproofing membrane 17 comprising a sealing material layer 12, layer of waterproofing that is sandwiched between a support sheet 14 on one side and an impervious surfacing material 13 to the opposite side of sealing material layer 12.

Referring to FIG. 2, the laminated panel 10 of the invention applied on a construction structure 16 which can be made of concrete, wood or other material to be sealed or protected against atmospheric air and/or vapor. Fasteners 24, such as, but not limited to, nails, screws, or staples, which extend through laminated panel 17 and into construction structure 16 are sealed by the waterproofing material of layer 12 to avoid any leakage or passage of air, gas, vapor, or water through the wall or the laminated panel. Air or water or including waterproofing material 12 that is sufficiently resilient and adhesive to tightly surround fasteners 24 typically used in such constructions to attach the laminated panels and to the structure

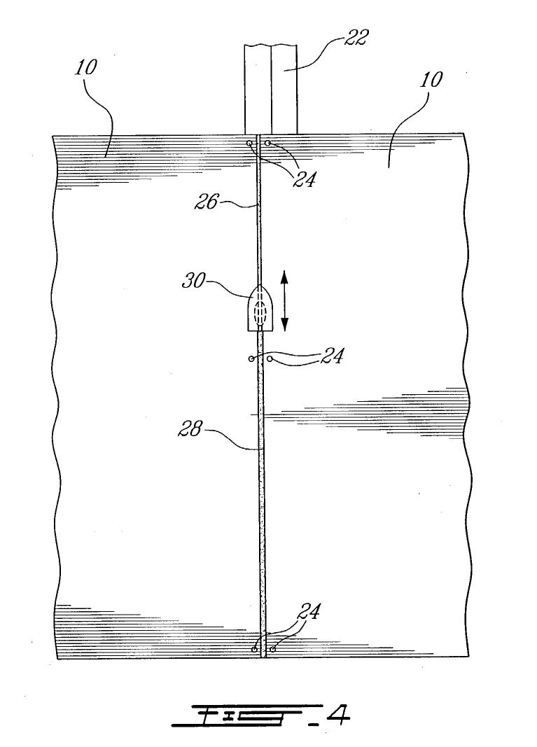

In FIG. 3, it will be seen that a laminated panel 10 according to the present invention, in addition to preventing air, gas, water or vapor infiltrations through studs 22 on which it is fastened, by means of waterproofing membrane 17, allows the application of an insulating material 18 on, for example, a gypsum board 20.

According to FIG. 4, it will be seen that the panels 10 of the invention can be installed, for example, side by side in a row and/or column and fastened to a stud 22 with fasteners 24 known in the art. Joint 26 between two adjacent laminated panels 10, can be sealed by using a heating device 30, for example, such, as a hot plate, that causes the waterproofing material of the waterproofing membrane of a laminated panel to reach a temperature closed or slightly above its melting point and fuse with the waterproofing material of an adjacent laminated panel to form a seal 28. In this way, all vertical seams between side by side adjoining panels and all horizontal seams between vertically stacked adjoining panels 10 can be self-sealed by the fused waterproofing material. The sealed seams can be optionally covered with some tape depending on the needs.

According to an embodiment of the present invention, support sheet 14 is sufficiently porous to permit the waterproofing. Surprisingly, it has been observed that the use of a support sheet, according to the invention, which does not to be removed when applying the waterproofing membrane on a surface to be sealed or protected, renders the integrated air/vapor barrier membrane more resistant to stretching, easier to handle and apply, and allows for stability and efficiency of the sealing to be provided on a surface.

Fastening the laminated panel of the present invention with fasteners on a surface to be sealed or protected does not require the use of a tape adhesive or a sealer on a portion of the fasteners. The warming action induced by the passage or rotation of the fastener through the waterproofing membrane, causes the waterproofing material to adhere to the fastener and self-seal same.

Under the action of heat the impervious material can melt to create an adhesive surface to self-adhesively receive insulating material.

Upon heating, the waterproofing material of a membrane reaches a temperature above its softening point, transpires or transudes to the laminated panel and fuses with the heated waterproofing of an adjacent piece, band or sheet of the barrier membrane, therefore creating an uninterrupted layer of sealing material on the surface on which it is adhered. Alternatively, the waterproofing membrane can be joined to an adjacent piece or band or sheet of barrier membrane of the instant invention with a tape applied concomitantly at the juncture of both laminated panel.

The surface that can be covered or provided with the laminated panel of the present invention can be longer and wider that other panels known in the art.

The waterproofing material has a coating temperature enabling it to be coated on an impervious or impermeable film, sheet or plaque, as a viscous liquid. The sealing material may alternatively be coated, for example, below its flowing temperature, say between about 80° C. to 115° C., on another film or support sheet which is permeable to the waterproofing material where the temperature of the waterproofing material is above its softening temperature, which may be for example of 100° C. The softening and flowing temperatures of the waterproofing material may vary depending on its composition.

The layer of waterproofing of the present invention is preferably made of a polymer-modified bitumen such as a styrene-butanediene-styrene (SBS) block polymer, and can include one or more fillers such as limestone or the like to provide the desired consistency and physical properties for use in the integrated membrane. Various types of fillers are commonly used in this type of mixture. Among them, it is possible to include slate powder, calcium carbonate, talc, kaolin and other compounds which are well-known in the art. The reason for using a filler is to increase the stability of the mixture. Preferably, the filler used may be of a size to pass through a 75-micron screen, although fillers which can pass through a 60-micron (200-mesh) screen may also be used.

The present invention utilizes a wide variety of materials to form the support sheet of the air/vapor barrier membrane of the present invention. Alternatively, a support sheet formed with for example, but without limiting it to, an impervious material can be substantially impermeable to air, vapor and water and, based on the air/vapor barrier membrane's end use, capable of stretching following a movement of the surface to which it is ultimately applied. The support sheet can be formed of natural rubber or of a synthetic organic polymer such as polyethylene, polyvinylchloride, fluoroplastics, sulfone polymers, polyvinylidene, polypropylene or other polyolefins, a polyamide, a polyester, for example a polyethylene terephthalate, a polyurethane, a polyvinyl halide, such as a polyvinyl chloride and copolymers thereof, such as a copolymer of polyvinyl chloride and vinylidene chloride, a synthetic rubber, such as polychloroprene or butyl rubber, regenerated cellulose, cellulose, cellulose ethers or cellulose esters.

The support sheet may have a porosity that is calibrated or adjusted to allow for the transudation of a sealing material at one side, and transudation of glue at the other side. In this manner, contact between the waterproofing material and the glue is done inside the support sheet.

According to the invention, the support sheet may be a film in the form of a solid sheet, a cellular film or a woven and non-woven fabric that are sufficiently non-porous to restrict the flow of a hot bituminous composition therethrough. The air/vapor barrier may be used to make impervious, structures or surfaces constructed of, for example, wood, metal, plastics, or concrete. Even if these types of boards are air- and water-penetrable either inherently or as a result of imperfections such as cracks or pores, the laminated panel in itself constitutes an excellent barrier against atmospheric air and vapor. Rendering a surface or structure impervious as described herein means eliminating the ability of air, vapor and water to penetrate or pass through the surface or structure, such as a wall of a building for example, or between two rooms in a building.

The laminated panel of the present invention may also be used also as a weather proofing panel which is intended to be laminated to most common building sheathing material such as gypsum boards, perlite boards, wood fiber boards, insulating board or plywood.

According to the present invention, in addition to providing a protection against atmospheric air, gas, vapor, humidity, or water, the barrier membrane may constitute an adhesive between two surfaces, therefore allowing the possibility of fixing a supplementary board on a surface already sealed or protected with a laminated panel of the present invention. The laminated panel can therefore be considered as being self adhesive. For example, the laminated panel can applied on a surface, such as a concrete foundation, a wall structure, or a wall, against which a insulating panel or any insulation material has already been. The laminated panel according to the invention, may dispense with the use of nails, screws, glue or any other device for fixing such a material, the barrier membrane still keeping its air and vapor barrier characteristics. However, even when the laminated panel of the present invention is secured against a wall, a structure, or a building structure with screws, staples, or nails, it remains sealed, airproof and waterproof.

The laminated panel of the present invention when used as a building envelope allows for providing a continuous air and vapor barrier to control air or vapor leakage into, or out of the sealed or protected space. The laminated panel is also useful for interior partitions between sealed or protected spaces designed to maintain temperature or humidity levels which differ from those in the sealed or protected space by more than 50%.

The laminated panel of the present invention may be continuous, with all joints made air- and vapor-tight with or without glue, tape or any other additional method other than heating the joints.

The present laminated panel according to the invention is capable of withstanding positive and negative wind, fan and stack pressures on the envelope without damage or displacement, and allows transfer of the load to the structure. The laminated panel of the present invention is stable between adjacent structures or materials under different physical constraints.

The laminated panel according to the invention allows to connect different construction structures, such as between foundation and walls, walls and windows or doors, between different wall systems, wall and roof, wall and roof over sealed or protected space, wall, floors and roof across construction, control and expansion joints, and between walls, floors and roof to utility, pipe and duct penetrations.

The embodiments of the invention described above is (are) intended to be exemplary only. The scope of the invention is therefore intended to be limited solely by the scope of the appended claims.

I/we claim:

1. A laminated panel substantially impervious to atmospheric air and vapor comprising a board, said board having one surface covered with a sealing membrane, said sealing membrane comprising a layer of sealing material having one side coated with a layer of impervious non transudent surfacing material that is in adhesive contact with said layer of sealing material, and a second side coated with a support sheet comprised of a therethrough so as to allow said sealing membrane said board.

2. The laminated panel of claims 1, wherein said support sheet is sufficiently porous to permit passage of said sealing material therethrough.

3. The laminated panel of claim 1, wherein said adherent support sheet is penetrated by an adhesive material previously applied thereto or on a surface on which said integrated sealing membrane is applied.

4. The laminated panel of claim 1, wherein said sealing material comprises a water repellant material selected from the group consisting of a transudent bitumen, a transudent polymer, a transudent resin, and a mixture thereof.

5. The laminated panel of claim 1, wherein said board is a panel of wood, concrete, gypsum, perlite, kraft, foam, wood fiber, plywood, insulating material, a paper sheet, or a metallic sheet.

6. The laminated panel of claim 5, wherein said bitumen is a polymer-modified asphalt.

7. The laminated panel of claim 1, wherein said layer of sealing material has a thickness of between 0.1 to 8 mm.

8. The laminated panel of claim 1, wherein said impervious non transudent surfacing material is selected from the group consisting of a polymer, a resin, a plastic, a metal, a polyester, a polypropylene, a polybutyrene, a polyimide, a polycarbonate, a polyamide, a polyethylene, a polystyrene, a polyvinylchloride, a fluoroplastic, a sulfone polymer, and a polyvinylidene chloride.

9. The laminated panel of claim 1, wherein said support sheet is made of fiber comprising Kraft paper, a fabric, or a mixture thereof.

10. The laminated panel of claim 1, wherein said sealing material further comprises up to 40% by weight of a filler.

11. The laminated panel of claim 1, wherein said sealing material comprises between 50 to 100% of bitumen, and up to 50% by weight of at least one copolymer, wherein combination of said bitumen and said copolymer forms 100% of said sealing material.

12. The laminated panel of claim 11, wherein said bitumen copolymer combination is a styrene-butadiene-styrene, block copolymer.

13. A method for protecting a construction against atmospheric air or vapor comprising:
a) providing a laminated panel as defined in claim 1;
b) heating said laminated panel on a side of said sealing membrane having said layer of impervious non transudent, surfacing material for a time and a temperature allowing said side to become adhesive; and
c) applying the heated laminated panel of step b) on a construction surface in manner to allow self-adhesion of the laminated panel to said construction surface.

14. The method of claim 13, which comprises laminating said board with said sealing membrane before or after adhesion to said construction surface.
